(19) United States
(12) Patent Application Publication
(10) Pub. No.: US 2007/0226045 A1
(43) Pub. Date: Sep. 27, 2007

(54) System and method for processing preference data

(76) Inventor: Zhimin Chen, Aurora (CA)

Correspondence Address: ZHIMIN CHEN, 52 Ostick St., Aurora, ON, L4G 7K5, CA

(21) Appl. No.: 11/726,600

(22) Filed: Mar. 23, 2007

Related U.S. Application Data
(60) Provisional application No. 60/784,595, filed on Mar. 23, 2006.

(51) Int. Cl. G07G 1/00

(52) U.S. Cl. 705/10

(57) ABSTRACT

A method and system for facilitating the offering, marketing and sale of one or more products and services which receives at least one identifier of a first product associated with a first vendor; receives preference data associated with said at least one identifier from at least one consumer; presents data related to said at least one identifier to at least one additional vendor; receives at least one message related to said at least one identifier from said a first vendor or said at least one additional vendor, and responds to said at least one consumer according to said at least one identifier using said at least one message.

### CROSS-REFERENCES TO RELATED APPLICATIONS

This application claims benefit from U.S. provisional application No. 60/784,595 filed on Mar. 23, 2006, entitled “System and method for processing preference data”;

U.S. patent application Ser. No. 11/284,946, entitled “Method for analyzing and ranking data ranges in an n-dimensional space”; and

U.S. patent application Ser. No. 11/284,947, entitled “System and method for gathering and analyzing consumer preference data”.

### FIELD OF THE INVENTION

The present invention relates to a system and method for facilitating the offering, sale and marketing for satisfying market needs, and is more particularly concerned with a computer-based system and method for gathering, analyzing and reacting to consumer preference data associated with said market needs.

### BACKGROUND OF THE INVENTION

Understanding consumer preferences for products and services is vital to the long-term viability and profitability of a business. Reacting to changing consumer preferences and trends by targeting, tailoring and/or customizing products and services to specific consumers or niche consumer markets enables businesses to attract and retain loyal consumers. On the other hand, consumers also demand that businesses meet their needs according to their preferences as much as possible.

Generally, consumers of products and services are viewed by businesses or vendors from two different perspectives: actual customers and non-customers. Vendors are aware of actual customers and their preferences in view of past purchases made by these customers from the vendor. Non-customers comprise of individuals who have not made purchases from the vendor in the past, or for whom the vendor has no preference data. Non-customers can, in turn, be further classified into two sub-groups of individuals. The first sub-group includes uninterested individuals having no need or desire to purchase products or services from the vendor. The second sub-group includes interested individuals having some degree of need or desire for the specific products or services, but such need or desire is not strong enough for them to justify making the final decision to purchase the product or services.

Given the potential purchasing power of this second sub-group of non-customers, it is important for the vendors to address the needs and desires of this sub-group of individuals and to encourage them to purchase their products or services. This second sub-group of non-customers is still consumers as the actual customers. Consider the following typical example of an interested consumer shopping for a camera. The consumer visits a camera retail website and finds a camera costing $300.00. However, the consumer's acceptable price range is only $260.00. Although he is unwilling to purchase the camera at $300.00, he would be willing to purchase the camera if the price fell below $260.00. The interested consumer will not purchase the camera at the current price. Rather, he may choose to revisit the website in the future to determine whether the price for the camera has been reduced. Alternatively, the interested consumer may choose to visit a competing retail website or refrain from purchasing the camera entirely. From the perspective of the retail website, an immediate sale and potential long-term consumer has been lost. Since the retail website does not know why the interested consumer decided to forego the purchase of the camera, they will be unable to target or tailor its marketing and sales campaigns to attract these interested consumers in the future.

Assuming that the camera website typically has 300 consumers visit in any given day, and only 60 of these consumers actually purchase the aforementioned camera, the website's consumer preference data is limited to the preferences of this small segment of purchasing consumers. The website has no data pertaining to the preferences of the remaining 240 potential consumers, including why these individuals chose not to purchase the camera on that particular visit. It is reasonable to assume that at least 120 individuals within the sub-group of potential consumers are, in fact, interested in purchasing the camera in the near future if the price decreased, for example. Without proper systems and methods for tracking the preferences of interested and uninterested consumers, many vendors are overlooking a potentially large market segment of consumers. Knowing the preferences of these consumers would enable a vendor to better market its products and services to interested consumers so as to encourage additional actual sales.

In some cases, a business may not want to satisfy the purchasing needs of this second sub-group of consumers for various reasons, for example, high cost structure or a need for different market strategies. In these cases, the second sub-group of consumers has to spend huge efforts to look up the same or similar products/services elsewhere to meet their need. For example, these consumers usually have to conduct extensive search online to look for the best deals. At the same time, for those businesses which operate at a cheaper cost structure and which can meet the need, they don't know where to access the group of consumers.

In some other cases when supply is limited, a buyer may want to purchase a product at a price perhaps higher than a regular market price. He might want to post his willingness to pay a higher price to make a purchase so that an immediate need can be satisfied.

With the increasing popularity of the Internet, several on-line mechanisms can provide help to the second sub-group of non-customers to meet their need. For example, a comparison shopping web site can let the consumers find the same or similar products with relatively fewer efforts. Alternatively, the consumers can also go to an online market place to bid for their interested items. However, these two approaches are limited by the scopes of their listings. Moreover, auctions in online marketplace may be lengthy. For example, it takes days in most cases for each item to be auctioned individually. The existing need of the consumers is not exposed to the maximum market supply. Another alternative is to list their need in a listing service. However, as the needs in a listing service is highly fragmented and individualized, it is difficult to identify and address the needs in a collective manner. Another approach is to have consumers subscribe to sales channels or newsletters from a specific site. However, with this approach, consumers have to subscribe to numerous channels and newsletters from various sites in order to receive sufficient promotion information. The consumers often end up with receiving overwhelming irrelevant marketing messages daily and spams. These approaches neither achieve maximum market efficiency nor give the most convenience to consumers.

Accordingly, there is a need for a system and method for consumers search for preferred items and offers more effectively. There is a need for a system and method for consumers to receive highly relevant deals according to individual needs. There is a need for a system and method for gathering, analyzing and reacting to the preferences of consumers. There is a further need for a system and method for gathering reliable and accurate preference data that enables vendors to react to the current preferences of consumers. There is also a need for allowing demand and supply to both be fully informed and for conducting vendor-to-vendor competitions and consumer-to-consumer competitions in a free market to achieve maximum market efficiency.

### BRIEF DESCRIPTION OF THE DRAWINGS

For a better understanding of the present invention, and to show more clearly how it may be carried into effect, reference will now be made, by way of example, to the accompanying drawings which show preferred embodiments of the present invention, and in which:

FIG. 1 is a schematic diagram illustrating an information retrieval and communication network in an embodiment of the present invention;

FIG. 2 is a flowchart illustrating steps in a method of facilitating the offering, sale and marketing of one or more products and/or services in an embodiment of the present invention;

FIG. 3 is a sample interface illustrating an example in an embodiment of the present invention;

FIG. 4 is a sample interface illustrating an example in an embodiment of the present invention;

FIG. 5 is a chart illustrating storage data structure in an embodiment of the present invention;

FIG. 6 is a chart illustrating sample data in an embodiment of the present invention;

FIG. 7 is a flowchart illustrating steps in a method of facilitating the offering, sale and marketing of one or more products and/or services in an embodiment of the present invention;

FIG. 8 is a sample interface illustrating an example in an embodiment of the present invention;

FIG. 9 is a chart illustrating sample data in an embodiment of the present invention;

FIG. 10 is a sample interface illustrating an example in an embodiment of the present invention;

FIG. 11 is an sample interface illustrating an example in an embodiment of the present invention; and

FIG. 12 is a chart illustrating sample data in an embodiment of the present invention.

### DETAILED DESCRIPTION OF THE INVENTION

The present invention relates to a system and method for use by a vendor for gathering consumer preference data supplied by consumers, analyzing the consumer preference data and reacting to the results of consumer preference data analysis by communicating with specific consumers whose preferences are subsequently satisfied in a computer network.

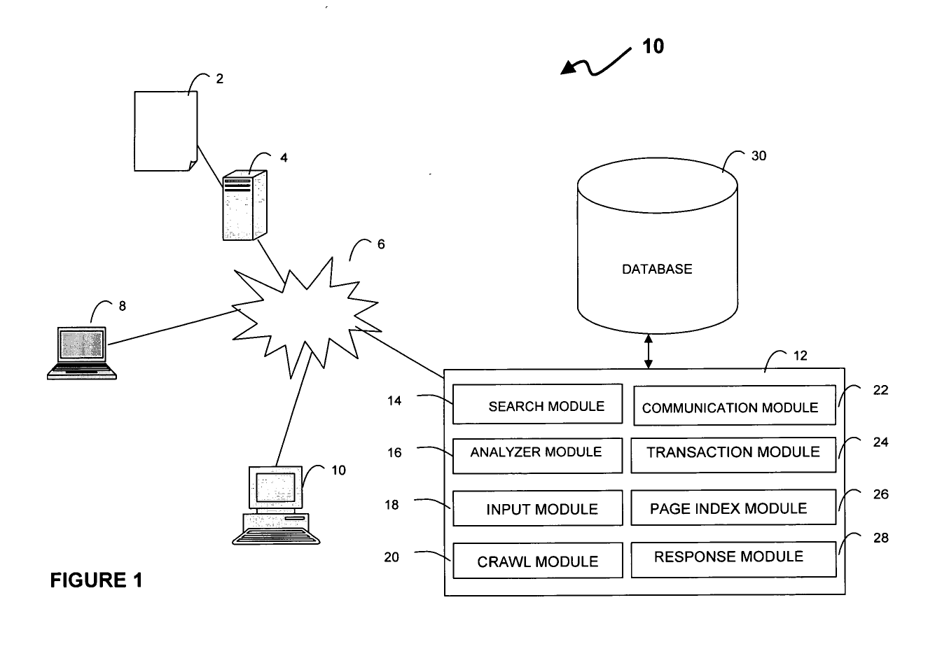

FIG. 1 illustrates an information retrieval and communication network including one or more web pages describing one or more products or services residing in a content server 4. It also includes one or more consumer client system 8 and one or more vendor system 10. It further includes an application server 12 and a database 30. Database 30 stores URLs (uniform resource locator) and preference data associated with the URLs. It might also store product and service information, consumer identifiers, payment information, contact information and demographic data. It might also store data associated with web pages. It's understood that database 30 could be multiple databases in various format, text file database or relational database for example. It could also be various databases connected by a computer network. Application server 12 includes a search module 14 for searching database 30, analyzer module 16 for analyzing preference data. Application server 12 further includes input module 18 for adding data into database 30 and crawl module 20 for crawling web pages associated with stored URLs in database 30. Application server 12 further includes communication module 22 for communication and transaction module 24 for conducting transactions. It still includes a page index module 26 for building page index for search and a query response module 28. It should be understood that application server 12 consists of one or more servers and various modules might reside on different servers which are connected by a computer network. Content server 4, consumer client system 8, vendor system 10 and application server 12 are connected to the Internet 6 or other communication network. Database 30 is connected to application server 12.

It will be appreciated that the consumer client system 8 and the vendor system 10 may be any computer, personal digital assistants (PDAs), cellular telephones, pagers, portable electronic mail messaging or other messaging devices, handheld organizers, portable computing devices or any other devices with browsing tool accessing the Internet or a computer network. Web page 2, content server 4 and vendor system 10 may belong to separate organizations or one single organization. In the specification, figures and claims, reference to a service provider or a service provider site includes any systems and/or web sites utilizing various embodiments of the invention.

In the specification and in the claims, reference to consumers or buyers includes the actual customers, the second sub-group of non-customers or any shoppers having buying interests. It should be understood that consumers or buyers may be any individual buyer or an entity. While the invention illustrates the case of consumer purchasing products or services from vendors (B2C), the invention also applies to B2B industries. This invention also applies to any business purchase from another business or individual vendor.

In the specification and in the claims, reference to the preferences of a consumer or the preference data may include, for example, the identity of products and/or services that the consumer is interested in purchasing, such as Stock Keeping Unit (SKU), barcode, International Standard Book Number (ISBN), or Radio-frequency identification (RFID), the association between the consumer and the products and/or services in which the consumer is interested, the specific attributes of the products and/or services, images, audios and videos of the products and/or services, description of the products and/or services, the prices at which the consumer would be willing to purchase the products and/or services, consumer information, payment or accounting data, and any other data. The specific attributes of the products and/or services may include its size, availability, color, brand, model, financial terms, payment terms, features, add-ons, accessories, destination, duration and the quantity of products and/or services to be purchased. It should be understood that reference to the word “products” in the specification and in the claims may also include “services” or “products and services” together. Further, it should be understood that the term “attributes” may include any suitable features, characteristics or descriptive terms, for example, of the products and/or services.

The search modules 14 may reside on a system interface to receive search queries or analysis requests. Search module 14 processes queries and retrieve URLs or any web page identifiers, in some cases web pages, from database 30. The retrieved URLs or web page identifiers might be ranked according to the keyword input, various searching algorithms and the relevancy of preference data associated with the URLs and product identifiers. It may be also ranked according to the amount of preference data associated with the URLs.

Analyzer 16 may also reside on a system interface to receive analytical requests to processes the preference data based on the vendor specified policies to generate analysis results. The vendor specified policies may include criteria in respect to the products or services associated with the stored URLs in database 30, whose attempt is to determine the maximum price at which the consumer would decide to purchase the product or service. The vendor specified policies may also be based on data from various market sources, such as statistics, shipping time and cost, the manufacturer's suggested retail price for a product or service, the prices adopted by competing vendors, and/or the wholesale price of the product or service. The analyzer module 16 may also use various analysis algorithms, database analytical techniques, optimization algorithms for example. The analyzer module 16 may also be designed to limit the range of consumer preference data to control the quality of data received from consumers. For example, analyzer module 16 may be adapted to control or filter consumer preference data inputs which are intended by the consumer to skew the analysis results, such as, for example, by inputting a purposively low preferred purchase price.

Processed results outputted from search module 14 and analyzer module 16 are provided to response module 28 in human and/or computer readable formats. Response module 28 might render the search or analysis results into a HTML file and return it to a user issuing the search query or analytical request. Response module 28 may also output the results into files with various formats, XML, PDF, image formats or other downloadable formats.

Input module 18 may reside on a system interface to receive URLs and consumer preference data as input. It's also understood that input module may wholly, partially or not reside in application server 12. For example, input module 18 may present a web page interface in a site for a user input URLs and related preference data. It may also be a downloadable browser add-on installed in one or more browsers in consumer client system 8.

Communication module 22 may provide communication functions such as email, RSS, messaging or any other communication means to communicate with various parties. It may also optionally provide matching function before communication in order to ensure the accuracy of recipients. Communication module 22 may also deposit messages or status indicators into system user accounts in database 30. It may further broadcast messages across the computer network and/or proactively “push” messages to recipients.

Crawl module 20 may crawl web pages associated with the collected URLs stored in database 30 from other computers across computer networks or the Internet. It may crawl periodically or take snapshots whenever appropriate. Crawl module 20 may further verify the validation of the collected URLs. It may detect the availabilities of the URLs by crawling them periodically. It may process the URLs subsequently according to their availabilities or changing status. For example, it may mark an invalid URL as a dead link.

Page index module 26 provides indices for searching. It may pre-process the content of a web page accordingly. It may also extract appropriate content such as text or media content and construct indices according to various indexing algorithms. For example, an index may be constructed according to text keywords or the metadata of image files.

Transaction module 24 may provide transaction service to complete transactions for trading parties. The module may consist of various transaction protocols or systems in various embodiments. For example, it may consist of one or more auction systems according to one embodiment of the invention. It may also consist of a shopping cart system and/or a check out system. It should be understood that transaction module 24 may use any transaction system known in the art.

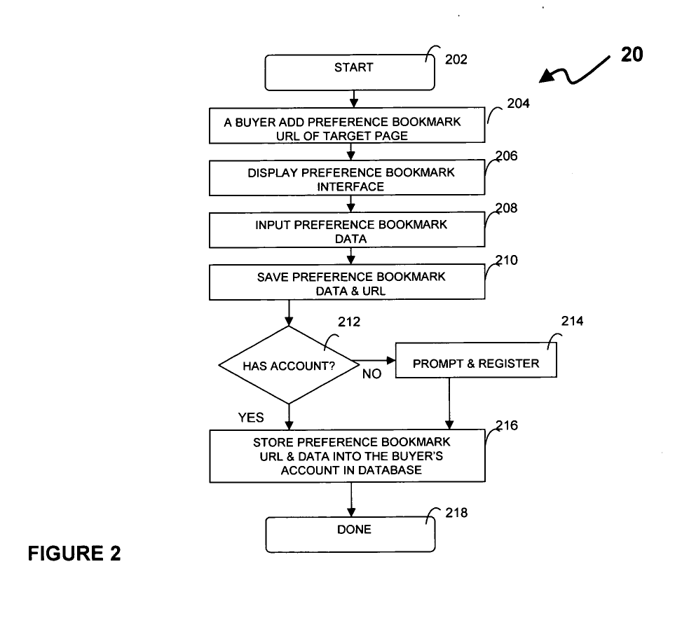

Referring to FIG. 2, steps in an embodiment of a method of gathering preference data submitted by a consumer are shown generally as 20, and commences at step 202. The method of the present invention will be described in the context of an offer by a website presenting a camera having a retail price of $300.00 to one or more consumers. It should be understood that the present invention may be utilized in respect to a wide variety of products and/or services.

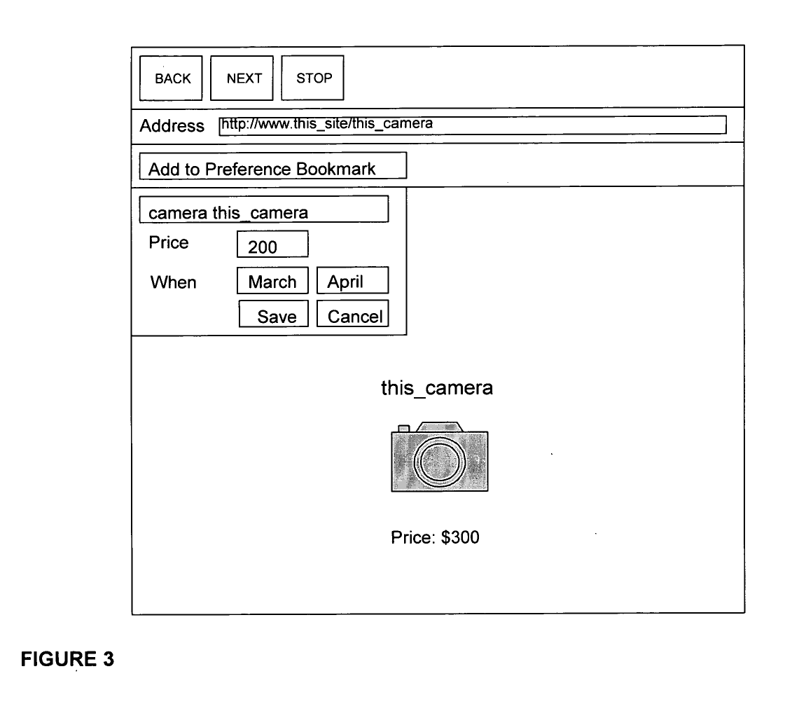

A buyer browsed Internet e-commerce sites using the consumer client system 8 and found a camera at a retail price of $300.00 in the website. He likes the camera but he knew somebody got the same kind of camera at $280. He thinks that he might be able to get it at a cheaper price. At Step 204, he clicks an add-on button “Add to Preference Bookmark” installed in his Internet browser to activate the process of inputting preference data of a product or service. FIG. 3 illustrates an embodiment of the invention that involves an installation of a toolbar with an add-on button “Add to Preference Bookmark”. It is understood that the add-on may be installed anywhere in a computer, a software application or any device where can be easily accessed. Like a regular bookmark feature “Add to Favorites . . . ”, the add-on button prompts with a data entry interface. At step 206, a preference bookmark interface is displayed. The interface may appear as a dropdown interface with an input box for describing the target product or service. It's understood that the interface may be implemented in any other forms known in the art. At step 208, the buyer input a text description of the camera in the target web page. In this example shown in FIG. 3, the input text may be “camera this_camera”. The word “camera” may represent a general category of the target product or service. The word of “this_camera” may represent a brand, a name of the manufacturer, or a model name or any information to describe the product or service. It's understood that a buyer may input any text or may not necessarily input any text or data to describe the product or service. It's also understood that the input of the text box can be automatically populated by the consumer client system 8 using a title of the target web page or any data collected from the web page. The interface may also consist of an input box, for example, the input box with a PRICE label, for a buy describing the price he wants to pay for the product or service associated with the web page and URL. In this example, the buyer input “200” in the price input box to indicate he would like to pay 200 dollars for the camera. The interface may further consist of other input boxes for a buyer describing when he might want to receive the product or service. In this example, the buyer input “March” and “April” respectively into two input boxes with a “WHEN” label to indicate he wants to receive this camera between March and April. It's understood that the interface may consist of any means and any number of data collection parameters for a buyer to describe any preference data of the product or service. It may be provided by the system in various embodiments or by user definitions.

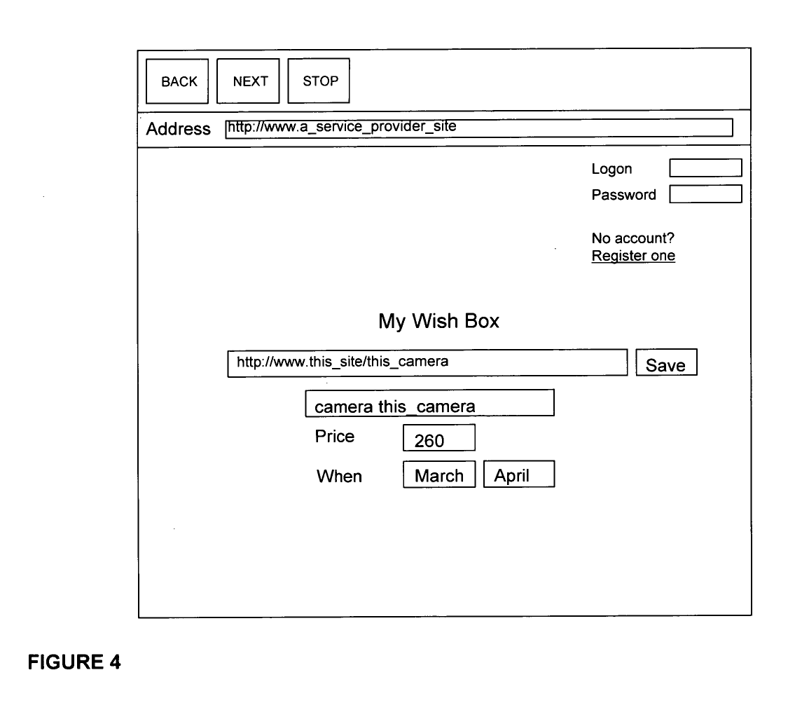

FIG. 4 illustrates another embodiment of the invention of preference bookmark interface at step 206. An interface may be displayed in a webpage by a service provider site implementing an embodiment of the invention. The webpage may consist of an input box for a buyer inputting the URL of the target web page with the product or service. In other embodiment of the invention, a buyer may input one or more other identifiers of the product, for example, Stock Keeping Unit (SKU), barcode, International Standard Book Number (ISBN), or Radio-frequency identification (RFID) into the input box. The webpage may also consist of other input boxes for a buyer to describe necessary preference data of the product or service. In FIG. 4, at step 208, a second user inputs his preference data of the same camera presented in the same web page seen by the first buyer. In this case, the second buyer inputs “camera this_camera” to describe the product he is interested and input “260” to indicate he would like to buy the camera at a price of 260 dollars. He also input “March” and “April” to indicate he would like to receive the camera between March and April.

At step 210, the buyers activates the “SAVE” button to save their preference data along with the URL of the target web page with the product or service. At step 212, in the embodiment of the invention illustrated in FIG. 3, the add-on toolbar detects that the user account has been created. At step 216, the toolbar saves the URL and the associated preference data into the buyer account in database 30. It's understood that the buyer account may be created by accessing a service provider web site. If an account for the buyer is not detected, at step 214, the toolbar may prompt the buyer to create an account. It's also understood that the buyer may be prompted for creating his account in database 30 when he installed the add-on toolbar. Once his account is setup, he may store his account name and password pair in the consumer client system 8 such that the add-on toolbar may automatically load his account name and password pair. In another embodiment of the invention, the toolbar may also prompt a user to input his account name and password if he has an account, or prompt a user to register an account if he hasn't created one. In the embodiment of the invention illustrated in FIG. 4, the second user may input his account name and password pair into the logon input box and password input box if he has created an account in database 30. Otherwise, the second buyer can register an account using a URL of “Register one” illustrated in FIG. 4. It's understood that any means in the art of user account creation or logon process maybe used. For example, in other embodiments, voice, fingerprint or other identification and authentication methods may also be used in addition to or instead of a user account name and password pair.

At step 216, the URL and associated preference data is stored into the buyer's account in database 30. The process ends at step 218.

In another embodiment of the invention, a buyer may conduct search on database 30 using a search interface. He may browse the returned URLs and identify the item he looks for and add preference data using the process illustrated in FIG. 2. In one embodiment of the invention, an initial record of a URL and associated preference data of a product may be pre-loaded on database 30 during system setup.

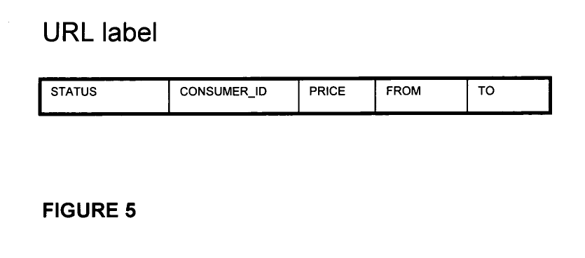

FIG. 5 illustrates a data structure storing the URL and associated preference data in one embodiment of the invention. The URL label indicates a named label using a URL to identify the data structure storing preference data associated with the URL. It should be understood that various data structures in the art may be used for storing URLs and associated preference data in various embodiments of the invention. In one embodiment of the invention, the labeled data structure may consist of fields including STATUS, CONSUMER_ID, PRICE, FROM and TO. The field STATUS indicates the status of a preference data. The CONSUMER_ID indicates the identification of a buyer associated with a preference data. The PRICE field indicates the price a buyer wants to buy. The FROM field and TO field indicate the acceptable date range receiving the expected product or service.

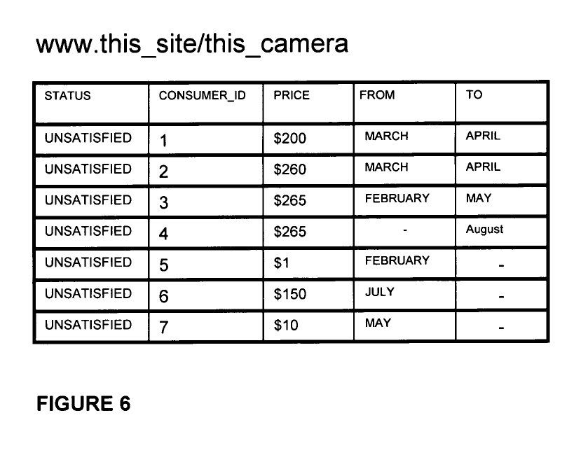

FIG. 6 illustrates a data structure storing a URL www.this site/this camera and its associated collected preference data in one embodiment. In this example of the embodiment of the invention, 7 preferences associated with URL www.this site/this camera from various buyers are collected. Buyer 1 with CONSUMER_ID=1 input his preference to indicate that he wants to buy this_camera between March and April at price $200. By default, the system assigns an input preference with STATUS=UNSATISFIED to indicate that a preference hasn't been satisfied. In one embodiment of the invention, STATUS is omitted as a preference is always computed as UNSATISFIED. A symbol “-” means no input has been entered for the corresponding field. For example, in the preference data input by buyer 4 with CONSUMER_ID=4, FROM field has “-” symbol. It means that buyer 4 expects to have the camera this_camera before August. Buyer 5, 6, 7 expect to receive this_camera after February, July and May respectively.

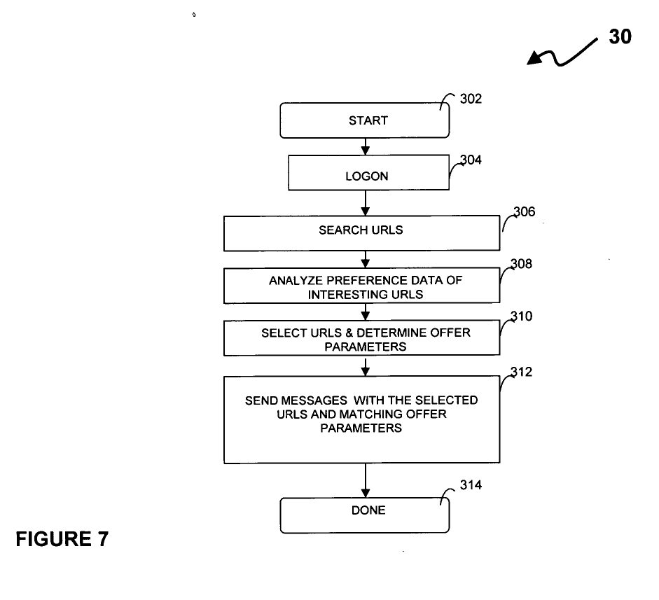

FIG. 7 illustrates one embodiment of the invention for a vendor meeting the potential market need. The process starts at step 302. At step 304, a vendor logon to his account created in a web site provided by a service provider. The account may be created in a separate time using any means of accounting creation and management known in the art. The logon method may use any means of logon methods known in the art.

At step 306, a vendor input queries to search database 30 to identify matching stored URLs. He may use any method known in the art to conduct a search. For example, a search may be a keyword search, string matching, URL and/or domain name matching, an expression or string pattern matching, category search, range search, sort or any combination. It's understood that a vendor may not issue any queries to search URLs. He may browse all the URLs directly to identify the interesting URLs. In one embodiment of the invention, a vendor may pre-define search queries which may be executed periodically by system according to configuration.

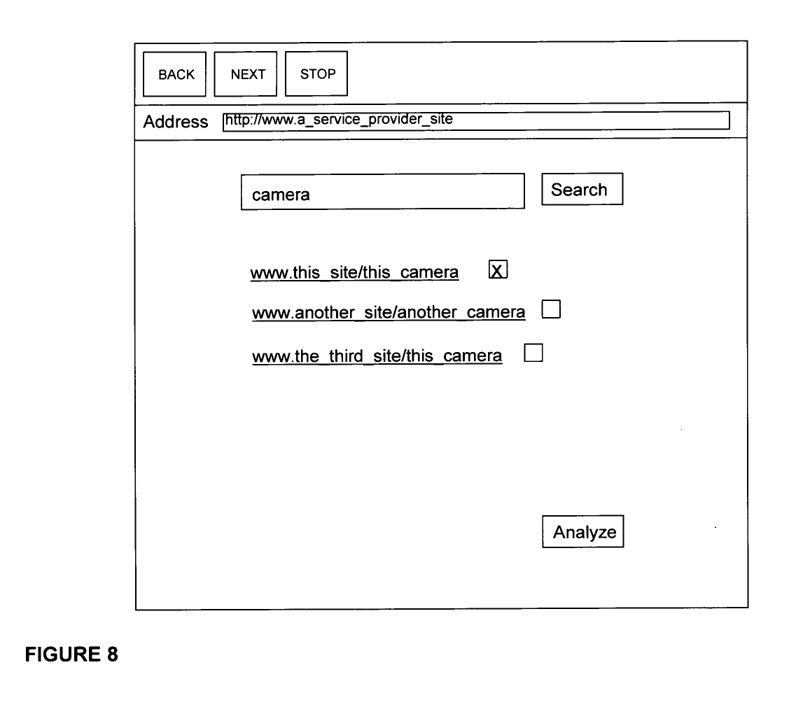

FIG. 8 illustrates one embodiment of the invention for a vendor conducting a search. A search interface consists of a query input box for a vendor inputting keywords. In this example, a keyword “camera” has been input and submitted. It's understood that any keyword or combination of keyword may be used. A list of hits is returned and is presented to a vendor issuing the search. In this example, three URLs matching the keyword search “camera” are returned. The list of hists may also consist of preference data for each returned URL as preview, for example, one or more images, small amount of text and price ranges. The order of the URLs may be ranked based on the result of various searching algorithms. In one embodiment of the invention, the URLs may be also ranked by the amount of the preference data associated with the URLs. The URLs may be also ranked by the values indicated by the preference data associated with the URLs. The URLs may be also ranked by the frequency of being visited. The URLs may be still ranked by the feedback rating on the URLs or the domains associated with the URLs. It may be also ranked by the relevancy of search queries. It should be understood that any ranking method may be used.

The vendor further browse the returned URLs to identify the product or service associated with the URLs that he may offer. In one embodiment of the invention, he identified that he wants to conduct a sale on this_camera associated with URL www.this site/this camera. He marks down the URL www.this site/this camera. In other embodiment of the invention, Step 306 may be executed automatically by system according to vendor pre-defined search queries and system configurations. The search results returned by the execution of pre-defined search queries maybe further selected according to other pre-defined filtering policies. The search results may be delivered to the vendor automatically by system using necessary communication means for example, email, RSS and messaging.

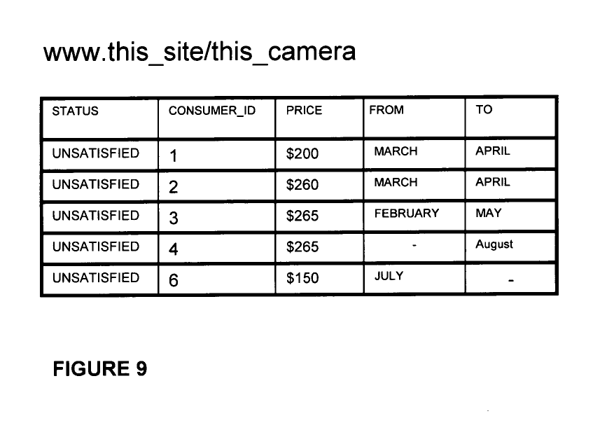

At step 308, he analyzes the preference data associated with the URL www.this site/this camera. In one embodiment of the invention, an range rank analytical method in U.S. patent application Ser. No. 11/284,946 may be used. It should be understood that any analytical method, windowing method, aggregation method, pattern matching method, sorting method, filtering method, estimation method or any combination may be used to analyze the preference data. In one embodiment of the invention, an analysis may apply filtering on the associated preference data to filter the disqualified preference data. FIG. 9 illustrates the result of preference data after filtering in one embodiment of the invention. Preference data associated with CONSUMERID 5, 7 are filtered because the associated prices are too low. It should be understood that any criteria may be used to filter preference data. For example, a filtering may be conducted based on an expected date, expiration, a price, a status, a quantity, an attribute, a system status or a buyer/vendor specified parameter.

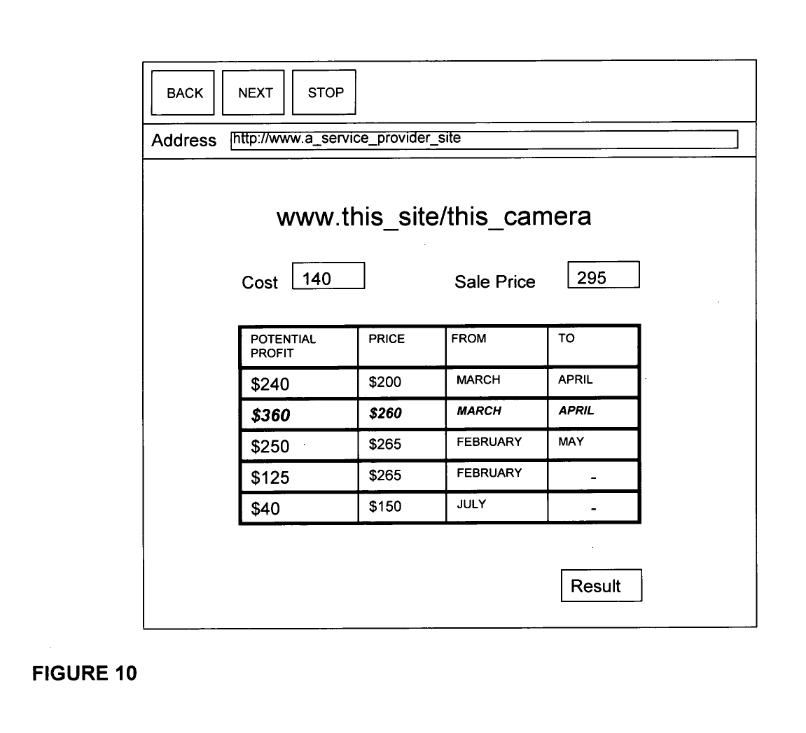

FIG. 10 illustrates the analytical result in one embodiment of the invention. An interface for a vendor analyzing the preference data is displayed. It may consist of an input box for a vendor entering the cost of this_camera. The cost may vary for different vendors. A vendor may not enter a cost into the cost input box. The interface may also consist of a sale price input box for a vendor entering the potential maximum price he wants to conduct a sale. The maximum price may filter the prices in preference data which are purposively higher than the current price. A vendor might not enter any price into this input box. In another embodiment of the invention, the interface may also consist of a sale price input box for a vendor entering the minimum price he wants to conduct a sale. The minimum price may filter the preference data with prices lower than the minimum price. In this example in one embodiment of the invention, a vendor enters “140” into the cost input box and “295” into the sale price box as a maximum price. He submits the numbers and clicks “Result” button to see the analytical result.

The analytical result displays the potential profit according to the price and expected time. It's understood that if a cost value is not input, the POTENTIAL PROFIT means potential revenue. It should also be understood that a vendor can pick any attribute to conduct an analysis. For example, he might decide to turn off FROM and TO and conduct analytical solely on price.

In another embodiment of the invention, preference data associated with multiple URLs may be collectively analyzed. If a vendor identifies that multiple URLs are associated with the same product, he may select multiple URLs together to conduct an aggregated analysis. In the example of analyzing the preference data of this_camera, if a vendor identifies that URL www.the third site/this camera is the same camera this_camera, he may also pick the URL www.the third site/this camera along with the URL www.this site/this camera together and conduct an analysis.

In one embodiment of the invention, a vendor may conduct analysis across multiple products associated with various URLs. For example, if a vendor decides to conduct sales on multiple products, he may select multiple URLs associated with the multiple products and conduct analysis together. In other embodiment of the invention, a vendor may pre-define analyzing and filtering policies to conduct analysis against at least one selected URLs or product identifiers. The pre-defined analyzing and filtering policies may be executed automatically by system according to configurations.

At step 310, a vendor determines a profitable opportunity after analyzing the preference data associated with a URL and he may decide to select the URLs as candidates and determine how to achieve the best sale result. In this example in one embodiment of the invention, a vendor can identify how to conduct a sale to achieve the best potential profit. He may conduct a sort based on POTENTIAL PROFIT to exam profit potential. In this example, he identifies that if he conducts a sale at a price of $260 between March and April, he might achieve a potential largest profit $360. In other embodiment of the invention, Step 310 may be performed automatically by system according to vendor pre-defined policies. The analysis result may be automatically delivered to the vendor by system using necessary communication means for example email, RSS and messaging.

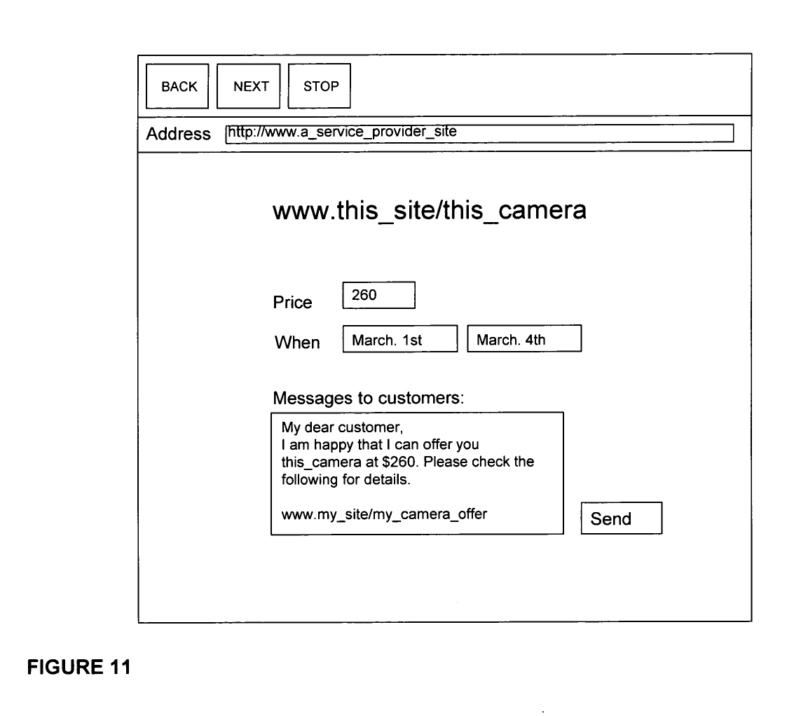

At step 312, a vendor decides to send out messages according to the determined URLs and the associated determined parameters. FIG. 11 illustrates an example in one embodiment of the invention. A vendor decides to conduct a sale on this_camera associated with the URL www.this site/this camera using the determined parameters, i.e. price $260 between March and April. An interface is displayed for a vendor to enter necessary message and parameters. The buyer decided to conduct a 4-day sale on this_camera between March 1^{st} and March 4^{th} at a sale price $260. He enters the price in a corresponding price input box and the dates into the corresponding date boxes presented in the interface. He may also include a necessary message including his detailed offer information into a message box and click on a “Send” box and send out the message. The process ends at step 314. It should be understood that contact information of corresponding buyers may be directly accessed or downloaded by vendors if the accessing of contact information have been authorized by corresponding buyers. In other embodiment of the invention, Step 312 may be performed automatically by system according to vendor pre-defined policies.

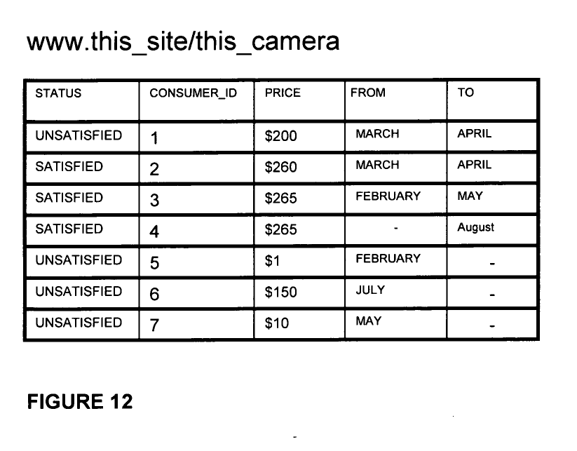

The sent message may be forwarded to the buyers whose preference data associated with the URL www.this site/this camera can be satisfied by the offer included in the message. The determination of recipients of the sent message can be conducted by any match, select or filter algorithms known in the art. In one embodiment of the invention, the sent message may be forwarded to any buyers whose preference data associated the URL www.this site/this camera and any URL related to the URL www.this site/this camera. FIG. 12 illustrates a result after determination of an example in one embodiment of the present invention. The preference data associated with the URL www.this site/this camera is processed against the provided offer of this_camera by the vendor. Preferences with CONSUMER_ID 2, 3 and 4 are determined that the offers can be satisfied by the provided offer and the status of the preference data are marked as STATISFIED. The sale message may be forwarded to buyers associated with the CONSUMER_ID according to the contact information specified by the buyers. In one embodiment of the present invention, a special flag in the installed toolbar in consumer client system 8 may be displayed to notify the buyer that he got an offer matching his preference requirements. In another embodiment of the invention, an email or a wireless message may be forwarded to the buyer if he authorizes to be contacted through an email account or wireless device. In another embodiment of the invention, a special flag may be displayed when a buyer logon to his account. In another embodiment of the invention, a notification message may be delivered using RSS (Really Simple Syndication). It should be understood that any communication method may be used to notify a buyer in various embodiment of the present invention.

In one embodiment of the present invention, a message has been sent to a buyer and the associated preference stored in the buyer's account will be marked as “Satisfied”. Once the buyer verifies, by visiting the enclosed information such as a web page or by communicating with the vendor, that the provided offer exactly matched the product he expected according to this preference, he might make the purchase directly from the vendor. He may rate the vendor according to his experience and provide feedback. In an alternative case, if he identifies that the provided offer does not match his expecting product, he might re-mark his preference as “Unsatisfied”. He may rate the vendor according to the exactness of matching the product and his preference. The rating may be collectively computed across users. The total rating may associate with the URL or domain name of the URL as feedback scoring. It may also associate with the vendor. It may also be made available as a separate indicator or used as an input of another scoring.

While what has been shown and described herein constituted a preferred embodiment of the subject invention, it should be understood that various modifications and adaptions of such embodiments can be made without departing from the present invention, the scope of which is defined in the appended claims.

1. A method for facilitating the offering, marketing and sale of one or more products among one or more vendors, said method comprising the steps of:
(a) receiving at least one identifier of a first product associated with a first vendor;
(b) receiving preference data associated with said at least one identifier from at least one consumer;
(c) presenting data related to said at least one identifier to at least one additional vendor;
(d) receiving at least one message related to said at least one identifier from said a first vendor or said at least one additional vendor, and;
(e) responding to said at least one consumer using said at least one message.

2. The method according to claim 1, further comprising the step of receiving feedback data from said at least one consumer.

3. The method according to claim 1, wherein said at least one identifier is a URL of a web page related to said a first product.

4. The method according to claim 1, wherein said at least one identifier is a SKU related to said a first product.

5. The method according to claim 1, wherein said at least one identifier is a barcode related to said a first product.

6. The method according to claim 1, wherein said at least one identifier is an ISBN related to said a first product.

7. The method according to claim 1, wherein said at least one identifier is a RFID related to said a first product.

8. The method according to claim 1, wherein the step of presenting data related to at least one identifier to at least one vendor, further comprises the sub-step of presenting data related to said at least one identifier to said at least one vendor in accordance with one or more pre-defined filtering criteria.

9. The method according to claim 1, wherein the step of presenting data related to at least one identifier to at least one vendor, further comprises the sub-step of analyzing data related to said at least one identifier.

10. The method according to claim 9, wherein the step of analyzing data related to said at least one identifier, further comprises the sub-step of analyzing data related to said at least one identifier in accordance with one or more pre-defined polices.

11. The method according to claim 1, wherein said at least one message is related to said a first product.

12. The method according to claim 1, wherein said at least one message is related to a second product.

13. A system for facilitating the offering, marketing and sale of one and more products among one or more vendors, said system comprising:
(a) a module adapted to receive at least one identifier of a first product associated with a first vendor;
(b) a module adapted to receive preference data associated with said at least one identifier from at least one consumer;
(c) a module programmed to present data related to said at least one identifier to at least one additional vendor;
(d) a module adapted to receive at least one message related to said at least one identifier from said a first vendor or said at least one additional vendor, and;
(e) a module programmed to respond to said at least one consumer using said at least one message.

14. The system claimed in claim 13, further comprising at least one module programmed to receive feedback data from said at least one consumer.

15. The system claimed in claim 13, wherein said at least one identifier is a URL of a web page related to said a first product.

16. The system claimed in claim 13, further comprising a module programmed to analyze data related to said at least one identifier.

17. The system claimed in claim 13, wherein said at least one message is related to a second product.

18. A method for facilitating the offering, marketing and sale of one or more products, said method comprising the steps of:
(a) receiving at least one URL of a web page related to a first product;
(b) receiving preference data associated with said at least one URL from at least one consumer;
(c) presenting data related to said at least one URL to at least one vendor;
(d) receiving at least one message related to said at least one URL from said at least one vendor, and;
(e) responding to said at least one consumer using said at least one message.

19. The method according to claim 18, further comprising the step of receiving feedback data from said at least one consumer.

20. The method according to claim 18, wherein the step of presenting data related to at least one identifier to at least one vendor, further comprises the sub-step of presenting data related to said at least one identifier to said at least one vendor according to pre-defined filtering criteria.

21. The method according to claim 18, wherein the step of presenting data related to at least one identifier to at least one vendor, further comprises the sub-step of analyzing data related to said at least one identifier.

22. The method according to claim 18, wherein said at least one message is related to a second product.

23. A system for facilitating the offering, marketing and sale of one and more products, said system comprising:
(a) a module adapted to receive at least one URL related to a first product;
(b) a module adapted to receive preference data associated with said at least one URL from at least one consumer;
(c) a module programmed to present data related to said at least one URL to at least one vendor;
(d) a module adapted to receive at least one message related to said at least one URL from said at least one vendor, and;
(e) a module programmed to respond to said at least one consumer using said at least one message.

24. The system claimed in claim 23, further comprising at least one module programmed to receive feedback data from said at least one consumer.
